(19) United States
(12) Patent Application Publication
(10) Pub. No.: US 2025/0094722 A1
(43) Pub. Date: Mar. 20, 2025

(54) ANNOTATION METHOD FOR LARGE LANGUAGE MODEL

(71) Applicant: BEIJING BAIDU NETCOM SCIENCE TECHNOLOGY CO., LTD., Beijing (CN)

(72) Inventors: Dai DAI, Beijing (CN); Hua Wu, Beijing (CN); Gangqiang Hu, Beijing (CN)

(73) Assignee: BEIJING BAIDU NETCOM SCIENCE TECHNOLOGY CO., LTD., Beijing (CN)

(21) Appl. No.: 18/968,920

(22) Filed: Dec. 4, 2024

(30) Foreign Application Priority Data
Feb. 5, 2024 (CN) 202410168741.4

(51) Int. Cl. G06F 40/30

(52) U.S. Cl. CPC G06F 40/30

(57) ABSTRACT

An annotation method for a large language model, an electronic device, and a medium are provided. The method may include: obtaining a plurality of response texts that are generated by a large language model for a request text and that meet a difference requirement; obtaining a plurality of scores corresponding to the plurality of response texts, where each of the plurality of scores indicates a degree to which a corresponding response text in the plurality of response texts matches the request text; and obtaining an annotated text for at least one of the plurality of response texts based on the plurality of scores, where the annotated text is used to adjust a parameter of the large language model.

### CROSS-REFERENCE TO RELATED APPLICATIONS

The present application claims priority to Chinese Patent Application No. 202410168741.4 filed on Feb. 5, 2024, which is incorporated herein by reference in its entirety.

### TECHNICAL FIELD

The present disclosure relates to the field of artificial intelligence technologies, in particular, to deep learning and large language models, and specifically, to an annotation method for a large language model, an electronic device, and a computer-readable storage medium.

### BACKGROUND

Artificial intelligence is a subject on making a computer simulate some thinking processes and intelligent behaviors (such as learning, reasoning, thinking, and planning) of a human, and involves both hardware-level technologies and software-level technologies. Artificial intelligence hardware technologies generally include technologies such as sensors, dedicated artificial intelligence chips, cloud computing, distributed storage, and big data processing. Artificial intelligence software technologies mainly include the following several general directions: computer vision technologies, speech recognition technologies, natural language processing technologies, machine learning/deep learning, big data processing technologies, and knowledge graph technologies.

Great progress has been made in generative artificial intelligence recently. A large language model (LLM) can receive a natural language input from a user, and output a natural language reply result. It is desirable to obtain annotated data for the large language model.

Methods described in this section are not necessarily methods that have been previously conceived or employed. It should not be assumed that any of the methods described in this section is considered to be the prior art just because they are included in this section, unless otherwise indicated expressly. Similarly, the problem mentioned in this section should not be considered to be universally recognized in any prior art, unless otherwise indicated expressly.

### SUMMARY

The present disclosure provides an annotation method for a large language model, an electronic device, and a computer-readable storage medium.

According to an aspect of the present disclosure, there is provided an annotation method for a large language model. The method includes: obtaining a plurality of response texts that are generated by a large language model for a request text and that meet a difference requirement; obtaining a plurality of scores corresponding to the plurality of response texts, where each score of the plurality of scores indicates a degree to which a response text corresponding to the score in the plurality of response texts matches the request text; and obtaining an annotated text for at least one response text of the plurality of response texts based on the plurality of scores, where the annotated text is used to adjust a parameter of the large language model.

According to another aspect of the present disclosure, there is provided an electronic device, including: one or more processors; a memory storing one or more programs configured to be executed by the one or more processors, the one or more programs including instructions for: obtaining a plurality of response texts that are generated by a large language model for a request text and that meet a difference requirement; obtaining a plurality of scores corresponding to the plurality of response texts, wherein each score of the plurality of scores indicates a degree to which a response text corresponding to the score in the plurality of response texts matches the request text; and obtaining an annotated text for at least one response text of the plurality of response texts based on the plurality of scores, wherein the annotated text is used to adjust a parameter of the large language model.

According to another aspect of the present disclosure, there is provided a non-transitory computer-readable storage medium storing computer instructions, where the computer instructions are used to cause the computer to perform the annotation method for a large language model according to one or more embodiments of the present disclosure.

It should be understood that the content described in this section is not intended to identify critical or important features of the embodiments of the present disclosure, and is not used to limit the scope of the present disclosure. Other features of the present disclosure will be readily understood with reference to the following description.

### BRIEF DESCRIPTION OF THE DRAWINGS

The accompanying drawings show example embodiments and form a part of the specification, and are used to explain example implementations of the embodiments together with a written description of the specification. The embodiments shown are merely for illustrative purposes and do not limit the scope of the claims. Throughout the accompanying drawings, the same reference numerals denote similar but not necessarily same elements.

FIG. 1 is a schematic diagram of an example system in which various methods described herein can be implemented according to an embodiment of the present disclosure;

FIG. 2 is a flowchart of an annotation method for a large language model according to an embodiment of the present disclosure;

FIG. 3 is a schematic diagram of a data flow of an annotation method for a large language model according to an embodiment of the present disclosure;

FIG. 4 is a block diagram of a structure of an annotation apparatus for a large language model according to an embodiment of the present disclosure; and

FIG. 5 is a block diagram of a structure of an example electronic device that can be used to implement an embodiment of the present disclosure.

### DETAILED DESCRIPTION

Example embodiments of the present disclosure are described below in conjunction with the accompanying drawings, where various details of the embodiments of the present disclosure are included to facilitate understanding, and should only be considered as example. Therefore, those of ordinary skill in the art should be aware that various changes and modifications can be made to the embodiments described here, without departing from the scope of the present disclosure. Likewise, for clarity and conciseness, the description of well-known functions and structures is omitted in the following description.

In the present disclosure, unless otherwise stated, the terms “first”, “second”, etc., used to describe various elements are not intended to limit the positional, temporal or importance relationship of these elements, but rather only to distinguish one component from another. In some examples, a first element and a second element may refer to a same instance of the element, and in some cases, based on contextual descriptions, the first element and the second element may also refer to different instances.

The terms used in the description of the various examples in the present disclosure are merely for the purpose of describing particular examples, and are not intended to be limiting. If the number of elements is not specifically defined, there may be one or more elements, unless otherwise expressly indicated in the context. Moreover, the term “and/or” used in the present disclosure encompasses any of and all possible combinations of listed terms.

The embodiments of the present disclosure will be described below in detail with reference to the accompanying drawings.

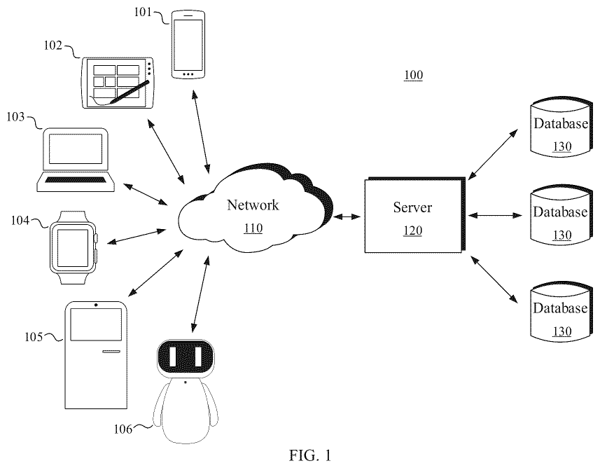

FIG. 1 is a schematic diagram of an example system 100 in which various methods and apparatuses described herein can be implemented according to an embodiment of the present disclosure. Referring to FIG. 1, the system 100 includes one or more client devices 101, 102, 103, 104, 105, and 106, a server 120, and one or more communication networks 110 that couple the one or more client devices to the server 120. The client devices 101, 102, 103, 104, 105, and 106 may be configured to execute one or more applications.

In this embodiment of the present disclosure, the server 120 can run one or more services or software applications that enable an annotation method for a large language model according to the present disclosure to be performed.

In some embodiments, the server 120 may further provide other services or software applications that may include a non-virtual environment and a virtual environment. In some embodiments, these services may be provided as web-based services or cloud services, for example, provided to a user of the client devices 101, 102, 103, 104, 105, and/or 106 in a software as a service (SaaS) model.

In the configuration shown in FIG. 1, the server 120 may include one or more components that implement functions performed by the server 120. These components may include software components, hardware components, or a combination thereof that can be executed by one or more processors. The user operating the client devices 101, 102, 103, 104, 105, and/or 106 may sequentially use one or more client applications to interact with the server 120, to use the services provided by these components. It should be understood that various different system configurations are possible, and may be different from that of the system 100. Therefore, FIG. 1 is an example of the system for implementing various methods described herein, and is not intended to be limiting.

The user may use the client devices 101, 102, 103, 104, 105, and/or 106 for annotation of a large language model, etc. The client device may provide an interface that enables the user of the client device to interact with the client device. The client device may also output information to the user via the interface. Although FIG. 1 shows only six client devices, those skilled in the art will understand that any number of client devices are supported in the present disclosure.

The client devices 101, 102, 103, 104, 105, and/or 106 may include various types of computer devices, such as a portable handheld device, a general-purpose computer (such as a personal computer and a laptop computer), a workstation computer, a wearable device, a smart screen device, a self-service terminal device, a service robot, a gaming system, a thin client, various messaging devices, and a sensor or other sensing devices. These computer devices can run various types and versions of software applications and operating systems, such as MICROSOFT Windows, APPLE IOS, a UNIX-like operating system, and a Linux or Linux-like operating system (e.g., GOOGLE Chrome OS); or include various mobile operating systems, such as MICROSOFT Windows Mobile OS, iOS, Windows Phone, and Android. The portable handheld device may include a cellular phone, a smartphone, a tablet computer, a personal digital assistant (PDA), etc. The wearable device may include a head-mounted display (such as smart glasses) and other devices. The gaming system may include various handheld gaming devices, Internet-enabled gaming devices, etc. The client device can execute various applications, such as various Internet-related applications, communication applications (e.g., email applications), and short message service (SMS) applications, and can use various communication protocols.

The network 110 may be any type of network well known to those skilled in the art, and may use any one of a plurality of available protocols (including but not limited to TCP/IP, SNA, IPX, etc.) to support data communication. As a mere example, the one or more networks 110 may be a local area network (LAN), an Ethernet-based network, a token ring, a wide area network (WAN), the Internet, a virtual network, a virtual private network (VPN), an intranet, an extranet, a blockchain network, a public switched telephone network (PSTN), an infrared network, a wireless network (such as Bluetooth or WIFI), and/or any combination of these and/or other networks.

The server 120 may include one or more general-purpose computers, a dedicated server computer (for example, a personal computer (PC) server, a UNIX server, or a terminal server), a blade server, a mainframe computer, a server cluster, or any other suitable arrangement and/or combination. The server 120 may include one or more virtual machines running a virtual operating system, or other computing architectures related to virtualization (e.g., one or more flexible pools of logical storage devices that can be virtualized to maintain virtual storage devices of a server). In various embodiments, the server 120 can run one or more services or software applications that provide functions described below.

A computing unit in the server 120 can run one or more operating systems including any of the above operating systems and any commercially available server operating system. The server 120 can also run any one of various additional server applications and/or middle-tier applications, including an HTTP server, an FTP server, a CGI server, a JAVA server, a database server, etc.

In some implementations, the server 120 may include one or more applications to analyze and merge data feeds and/or event updates received from users of the client devices 101, 102, 103, 104, 105, and 106. The server 120 may further include one or more applications to display the data feeds and/or real-time events via one or more display devices of the client devices 101, 102, 103, 104, 105, and 106.

In some implementations, the server 120 may be a server in a distributed system, or a server combined with a blockchain. The server 120 may alternatively be a cloud server, or an intelligent cloud computing server or intelligent cloud host with artificial intelligence technologies. The cloud server is a host product in a cloud computing service system, to overcome the shortcomings of difficult management and weak service scalability in conventional physical host and virtual private server (VPS) services.

The system 100 may further include one or more databases 130. In some embodiments, these databases can be used to store data and other information. For example, one or more of the databases 130 can be configured to store information such as an audio file and a video file. The databases 130 may reside in various positions. For example, a database used by the server 120 may be locally in the server 120, or may be remote from the server 120 and may communicate with the server 120 via a network-based or dedicated connection. The database 130 may be of different types. In some embodiments, the database used by the server 120 may be, for example, a relational database. One or more of these databases can store, update, and retrieve data from or to the database, in response to a command.

In some embodiments, one or more of the databases 130 may also be used by an application to store application data. The database used by the application may be of different types, for example, may be a key-value repository, an object repository, or a regular repository backed by a file system. The system 100 of FIG. 1 may be configured and operated in various manners, so that the various methods and apparatuses described according to the present disclosure can be applied.

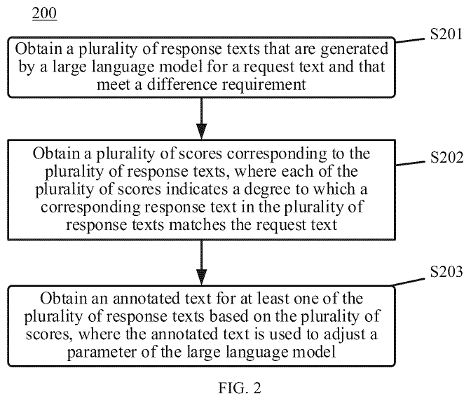

An annotation method 200 for a large language model according to an example embodiment of the present disclosure is described below with reference to FIG. 2.

At step S201, a plurality of response texts that are generated by a large language model for a request text and that meet a difference requirement are obtained.

At step S202, a plurality of scores corresponding to the plurality of response texts are obtained, where each of the plurality of scores indicates a degree to which a corresponding response text in the plurality of response texts matches the request text.

At step S203, an annotated text for at least one of the plurality of response texts is obtained based on the plurality of scores, where the annotated text is used to adjust a parameter of the large language model.

According to the method described in this embodiment of the present disclosure, annotated data for a large model can be obtained efficiently.

For example, the plurality of response texts different from each other may be generated by the large language model and scored, and the annotated text may be obtained based on the scores, so that costs can be reduced. It may be understood that the difference requirement may refer to that there are literal, form, meaning, and logic differences and/or differences in one or more other aspects between the response texts. The present disclosure is not limited thereto.

According to some embodiments, obtaining the annotated text for the at least one of the plurality of response texts based on the plurality of scores may include: determining a first response text as the annotated text in response to determining that a score, corresponding to the first response text, in the plurality of scores satisfies a threshold score condition.

In such an example, if the response texts include a text satisfying the score condition, the text may be determined as the annotated text. For example, a combination of the request text and the response text may be determined as the annotated text. In some examples, the annotated text may be referred to as a label. In another example, the annotated text may include another form of text used as an input of the model for adjusting or improving the model.

According to some embodiments, obtaining the plurality of scores corresponding to the plurality of response texts may include: obtaining, for each of the plurality of response texts, a level selected from a plurality of predetermined ordered levels as a score for the response text. In such an embodiment, the score satisfying the threshold score condition corresponds to the highest of the plurality of ordered levels.

For example, the score may be selected from a plurality of levels, or may be a plurality of enumerated scores, such as 1, 2, 3, 4, and 5. In this case, if there is the highest score, it is considered that the threshold score condition is satisfied and a satisfactory annotated text is found, and a text corresponding to the highest score is used as the annotated text. In this way, an annotation process can be greatly simplified.

According to some embodiments, obtaining the annotated text for the at least one of the plurality of response texts based on the plurality of scores may include: determining a second response text satisfying a modification condition from the plurality of response texts, in response to determining that none of the plurality of scores satisfies the threshold score condition; and obtaining a modified version of the second response text as the annotated text.

If the response texts include no text satisfying the score condition but a text that can be modified, a modified version of the text may be determined as the annotated text. Therefore, annotation is simplified.

As a specific example, the modification condition may be a condition set according to a predetermined rule. For example, it may be determined by a machine or by a person whether the predetermined rule is satisfied. The present disclosure is not limited thereto.

According to some embodiments, obtaining the annotated text for the at least one of the plurality of response texts based on the plurality of scores may include: obtaining an evaluation text for the at least one of the plurality of response texts as the annotated text in response to determining that none of the plurality of scores satisfies the threshold score condition and to determining that the plurality of response texts include no response text satisfying the modification condition.

If none of the generated response texts satisfies the score condition and is suitable to be modified, the evaluation text may be used as the annotated text, where the evaluation text may include an error explanation of why the text does not satisfy the score condition, so that the model can learn the problem therefrom. This improves effects of the model.

According to some embodiments, the difference requirement may indicate at least one of the following: a word segmentation difference and a reward model-based difference between the response texts.

In such an example, response texts that are different in text and/or response texts that are different in evaluation of a reward model may be selected, so that it is easier to select a suitable annotated text, and a case in which the texts are close and difficult to select is avoided.

According to some embodiments, the method may further include: before obtaining the plurality of scores corresponding to the plurality of response texts, obtaining a plurality of pieces of critique data corresponding to the plurality of response texts, where each of the plurality of pieces of critique data indicates an error in a corresponding response text, and the plurality of pieces of critique data are used for display in association with the plurality of response texts.

For example, in a scenario in which an annotator manually selects the scores, errors recognized from the texts may be displayed associatively to the annotator, to prevent the annotator from ignoring the errors in the texts. Therefore, more accurate annotated data can be generated.

According to some embodiments, the obtaining a plurality of pieces of critique data corresponding to the plurality of response texts may include: obtaining the plurality of pieces of critique data by checking a degree to which each of the plurality of response texts matches the request text.

In such an example, the critique data may include a degree to which a response matches a request, for example, whether the response meets a requirement mentioned in the request.

According to some embodiments, the obtaining a plurality of pieces of critique data corresponding to the plurality of response texts may include: obtaining the plurality of pieces of critique data by checking correctness of a fact recorded in each of the plurality of response texts.

In such an example, the critique data may include accuracy of a fact in the response. As a specific non-limiting example, when additional manual annotation is required, inclusion of the accuracy of the fact in the response in the critique data can reduce a workload of an annotator in determining the accuracy of the fact or a probability that no error is found. As another specific non-limiting example, the critique data may be displayed as a rule for manual annotation, for example, the related fact is displayed, and a human only needs to determine whether the response generated by the machine is consistent with the fact, so that objectivity and validity of an annotation result are ensured.

According to some embodiments, the obtaining a plurality of pieces of critique data corresponding to the plurality of response texts may include: obtaining the plurality of pieces of critique data by checking language expression of each of the plurality of response texts.

In such an example, the critique data may include linguistic fluency, a grammatical error, etc. of the response text.

According to some embodiments, the obtaining a plurality of pieces of critique data corresponding to the plurality of response texts may include: obtaining the plurality of pieces of critique data by checking correctness of logic of each of the plurality of response texts.

In such an example, the critique data may include correctness of a number, mathematical calculation, a logical problem, etc. in the response text, to provide a logical prompt for a possible problem in the response text, further ensuring correctness of the annotated data.

According to some embodiments, obtaining the plurality of response texts that are generated by the large language model for the request text and that meet the difference requirement may include: obtaining a response text set, where each response text in the response text set is generated by the large language model for the request text; and selecting the plurality of response texts from the response text set based on the difference requirement.

In such an example, the large model may be first caused to generate a plurality of texts, and then response texts that are greatly different are selected from the texts, so that a workload required for controlling the model to output different texts is reduced.

Great progress has been made in generative artificial intelligence (generative AI) recently. A conventional natural language processing (NLP) model for classification, information extraction, etc. usually receives a user input and then outputs a result in a fixed form. For example, for a classification task, the conventional NLP model receives a text to be classified and outputs a label for classification. When data annotation is performed for such a model, a human annotator only needs to select a predefined label for each text entered. Unlike the conventional model, a large language model (LLM) receives a natural language input (query, a query term) from a user, and directly outputs, in a token-by-token manner, a natural language reply result (response, response data). In addition, for a plurality of rounds of interaction, an input of the model further includes a historical context of a conversation between the user and the model, and the context may include a plurality of historical queries and response lists. Therefore, to train the LLM, one piece of training data needed may include one or more pieces of information in (context, query, response).

Because a reply (response) of the LLM is a natural language text, the human annotator needs to write or modify the whole response during data annotation for the LLM, resulting in much higher difficulty in data annotation for the LLM than that for the conventional NLP model. In addition to writing or modifying an annotation for supervised fine-tuning (SFT) data, such as the response, alignment training of the LLM further requires annotation for reply comparison data on which a reward model (RM) is dependent. A plurality of different responses of the LLM are sampled for the same query, and are scored and sorted by the human, to finally obtain a result of comparison between the responses, for training the reward model.

The difficulty in data annotation for the LLM is reflected in the following aspects:
1. Task diversity: With the improvement of capabilities of the LLM, the LLM can not only handle conventional NLP tasks (classification, information extraction, text summarization, etc.), but also handle more diverse NLP tasks, including, but not limited to, text creation, mathematical calculation, reasoning for puzzles, code generation, etc. These tasks are often more difficult and require long output replies, resulting in high difficulty in data annotation.
2. Instruction complexity: Conventional NLP tasks usually handle simple and single problems of users. However, the LLM can handle increasingly complex problems of the users based on its powerful capabilities, further resulting in high difficulty and extremely high costs in data annotation.
3. Various errors in replies: The LLM outputs diverse replies, so that there are many problems in the replies. Common problems include, but are not limited to, the following types:
a) instruction unfollowed: an output of the model cannot meet all requirements mentioned in a user input;
b) factual error: the model outputs a result that do not match an objective fact, or makes up an answer to a question that it is not able to answer;
c) linguistic non-fluency: there are linguistic incoherence, ill-formed sentences, or other language expression problems in the replies;
d) incorrect result: there are errors in results when the LLM performs a task such as writing code, doing math problems, or doing a logical puzzle; and
e) harmful reply content: the replies contain harmful and illegal information, or content that does not conform to human values.

The annotator needs to first find these errors from the replies, and make targeted modifications to all the errors, resulting in high difficulty in modification.

In summary, data annotation for the LLM is extremely difficult and costly, and there is an urgent need to find some way out, to reduce data annotation costs and improve annotation efficiency.

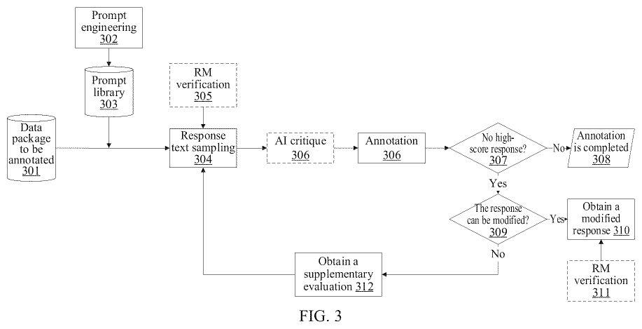

A schematic diagram of a data flow according to an example embodiment of the present disclosure is described next with reference to FIG. 3.

According to one or more embodiments of the present disclosure, there may be provided an annotation solution, including requesting a plurality of candidate responses based on a large model, then selecting a plurality of responses satisfying diversity from the plurality of candidate responses, and obtaining annotations and scores for the plurality of responses. This process may optionally be assisted by presenting self-critique of a critique model to a human.

For example, if at least one score satisfies a threshold (a score of the highest level), annotation ends; or if no score satisfies a threshold, the human determines whether a response corresponding to the current highest score can be modified are obtained. If the response corresponding to the current highest score can be modified, a modified response may be obtained for model training; or if the response corresponding to the current highest score cannot be modified, the human may provide more evaluations, the model performs modification again based on the evaluations, to obtain a better result, and the human performs annotation according to the foregoing process.

For example, a maximum iteration count N may be set. For example, it is set that at most N rounds of iteration are performed (for example, N may be equal to 3, but the present disclosure is not limited thereto). In such an example, annotation fails if there is no result with the highest score after the maximum number of rounds is reached. Therefore, time costs are reduced, and annotation efficiency is improved.

In addition, with the continuous improvement of the capabilities of the LLM, the LLM has shown extremely high capabilities in understanding complex tasks. With full use of these capabilities, the LLM may perform reflection and self-evaluation on generated replies by using the capabilities of the LLM or other external tools, and then modify errors in the previous replies based on errors found in self-evaluation.

In the manner of “self-critique” and then “self-correct”, the human annotator can improve the annotation efficiency by using the capabilities of the LLM. For example, the following may be included.

First, some errors that are difficult to find by the human annotator may be found through “self-critique” by using the LLM or another LLM-based tool, to help the human annotator find more problems in the reply. If these problems are easy to correct directly, the human annotator can directly correct the problems and complete annotation.

Then, if some errors are complex and difficult for the human annotator to correct directly, a “self-correct” capability of the LLM may be used. First, the human annotator may add some other errors not found through “self-critique” of the LLM. Then, the LLM performs modification again based on the result generated earlier and evaluations, to obtain a new and correct result.

In addition, another relevant model in LLM alignment training, such as a reward model (RM), may be used to further assist the human in determining whether the modified result is better than before. For example, given a user query and two replies generated by the LLM, the reward model may separately score the two replies, where a result with a higher score is considered as a better result. In this way, it is possible to quantitatively measure whether a reply obtained each time through manual modification is better.

As shown in FIG. 3, a plurality of candidate responses of the LLM model may be first requested by using data to be annotated, for example, a user query in a data package 301 to be annotated. For example, this may be implemented by using a prompt library 303 in prompt engineering 302.

Then, response text sampling 304 may be performed. A diversity control policy may be used during response text sampling. For example, literal similarity and/or RM verification 305 may be performed when the responses are requested from the model. RM verification may refer to controlling diversity of results by using scores given by the reward model (RM), etc. Therefore, results with great literal differences and/or reward score differences may be obtained.

For example, AI critique 306, for example, self-critique, may be performed on each result by using the LLM. It may be understood that a model for generating critiques may be a model specially trained for critiquing, for example, may be a variety of models that can be understood by those skilled in the art or that will emerge in the future to generate critiques. Alternatively, the model for generating critiques may be the large model with a critique capability.

Next, annotation 306 may be performed. For example, the human may perform RM-based data annotation. For example, the human sorts and scores a plurality of responses with reference to critiques given by the LLM and errors found by the human annotator (RM-based annotation), to generate annotated data for the reward model (RM). It may be understood that an output obtained in this step may be used to, for example, adjust or improve the RM model.

Later on, it is determined 307 whether there is no high-score reply. If all the candidates include a high-score response, that is, for example, a high-score result meeting a user requirement is found through RM annotation, etc., annotation is completed 308; or if no high-score result is found through annotation, it is necessary to determine whether the response can be modified 309. For example, it may be determined whether the response can be manually modified. However, the present disclosure is not limited thereto. For example, an error-free high-score result meeting the user requirement may be expected through modification. If it is determined that the response can be modified, for example, can be modified by a machine, or the human determines modification costs are not high, the response text may be modified, to obtain 310 a modified response. RM verification 311 may further be performed. For example, in a manual modification example, the RM model may be used to assist in determining whether a score obtained after manual modification is higher.

If it is determined that it is difficult to obtain a high-score result through direct modification, or if RM verification (not shown) is not satisfied, for example, the RM model determines that the score of the modified reply is much lower, the reply may be modified again, for example, modified by using the LLM. As a specific example, a supplementary evaluation may be obtained 312, for example, an additional error is found based on a previous evaluation given by the LLM. Then, the evaluation given by the LLM and the supplementary evaluation may be uniformly input to the LLM model, to generate a corrected reply based on the evaluations 313. The above process may be iteratively repeated for a plurality of times. When a maximum iteration count is set, if a response text satisfying a threshold score condition is not obtained when the maximum iteration count is reached, an annotation failure is marked, and an annotation task ends.

According to one or more embodiments of the present disclosure, efficiency of annotating LLM alignment data can be improved efficiently, thereby improving iteration efficiency of the LLM. For example, feedbacks may be collected from online users by using a specific method (for example, for queries and responses for which the online users provide negative feedbacks), and annotation of such data may be accelerated in an AI-assisted manner, to accelerate online effect iteration.

According to one or more embodiments of the present disclosure, the ability of the human annotator to find errors and correct complex errors may be significantly enhanced even in the case of manual annotation.

According to one or more embodiments of the present disclosure, AI-assisted annotation helps improve the efficiency and the accuracy of the human annotator, thereby accelerating generation of the LLM alignment data and accelerating online effect iteration. Once the self-evaluation and self-modification capabilities of AI reach a specific threshold, the model can be promoted to automatically modify and generate data, further reducing manual participation.

According to one or more embodiments of the present disclosure, a response sampling process includes requesting outputs from the large model with contexts and queries, and obtaining a plurality of results satisfying a diversity policy from a plurality of outputs. The diversity policy may indicate a difference in literal word segmentation or a difference in scores of the reward model. Then, scores of the several results are obtained. If at least one of the results has the highest score, that is, there is the highest score, the process ends; or if there is no highest score, whether a result with the highest score among the current results can be modified is determined. If the result with the highest score can be modified, the result with the highest score is modified; or if the result with the highest score cannot be modified, an evaluation is obtained (for example, why the requirement cannot be met) from the human, and is input to the model for learning and adjustment. The obtained annotation and score may also be used to train the RM model.

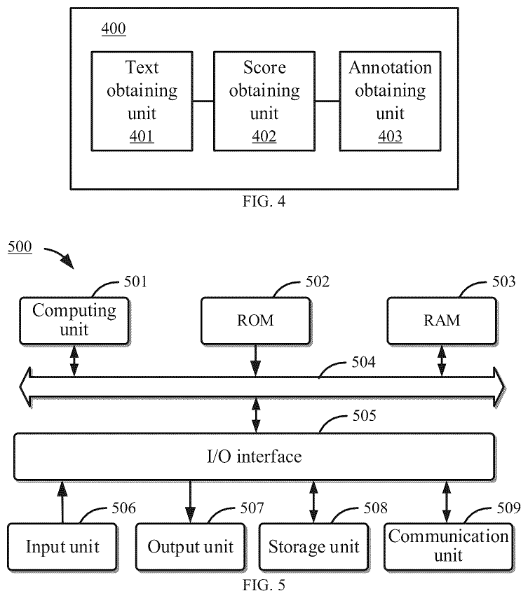

An annotation apparatus 400 for a large language model according to an embodiment of the present disclosure is now described with reference to FIG. 4. The annotation apparatus 400 for a large language model may include a text obtaining unit 401, a score obtaining unit 402, and an annotation obtaining unit 403. The text obtaining unit 401 may be configured to obtain a plurality of response texts that are generated by a large language model for a request text and that meet a difference requirement. The score obtaining unit 402 may be configured to obtain a plurality of scores corresponding to the plurality of response texts, where each of the plurality of scores indicates a degree to which a corresponding response text in the plurality of response texts matches the request text. The annotation obtaining unit 403 may be configured to obtain an annotated text for at least one of the plurality of response texts based on the plurality of scores, where the annotated text is used to adjust a parameter of the large language model.

According to the apparatus described in this embodiment of the present disclosure, annotated data for a large model can be obtained efficiently.

According to some embodiments, the annotation obtaining unit includes a unit configured to perform the following operation: determining a first response text as the annotated text in response to determining that a score, corresponding to the first response text, in the plurality of scores satisfies a threshold score condition.

According to some embodiments, the score obtaining unit includes: a unit configured to obtain, for each of the plurality of response texts, a level selected from a plurality of predetermined ordered levels as a score for the response text. In such an embodiment, the score satisfying the threshold score condition corresponds to the highest of the plurality of ordered levels.

According to some embodiments, the annotation obtaining unit may include a unit configured to perform the following operations: determining a second response text satisfying a modification condition from the plurality of response texts, in response to determining that none of the plurality of scores satisfies the threshold score condition; and obtaining a modified version of the second response text as the annotated text.

According to some embodiments, the annotation obtaining unit may include a unit configured to perform the following operation: obtaining an evaluation text for the at least one of the plurality of response texts as the annotated text in response to determining that none of the plurality of scores satisfies the threshold score condition and to determining that the plurality of response texts include no response text satisfying the modification condition.

According to some embodiments, the difference requirement may indicate at least one of the following: a word segmentation difference and a reward model-based difference between the response texts.

According to some embodiments, the apparatus may further include a unit configured to: before the plurality of scores corresponding to the plurality of response texts are obtained, perform the following operation: obtaining a plurality of pieces of critique data corresponding to the plurality of response texts, where each of the plurality of pieces of critique data indicates an error in a corresponding response text, and the plurality of pieces of critique data are used for display in association with the plurality of response texts.

According to some embodiments, the obtaining a plurality of pieces of critique data corresponding to the plurality of response texts may include: obtaining the plurality of pieces of critique data by checking a degree to which each of the plurality of response texts matches the request text.

According to some embodiments, the obtaining a plurality of pieces of critique data corresponding to the plurality of response texts includes: obtaining the plurality of pieces of critique data by checking correctness of a fact recorded in each of the plurality of response texts.

According to some embodiments, the obtaining a plurality of pieces of critique data corresponding to the plurality of response texts may include: obtaining the plurality of pieces of critique data by checking language expression of each of the plurality of response texts.

According to some embodiments, the obtaining a plurality of pieces of critique data corresponding to the plurality of response texts may include: obtaining the plurality of pieces of critique data by checking correctness of logic of each of the plurality of response texts.

According to some embodiments, the text obtaining unit may include a unit configured to perform the following operations: obtaining a response text set, where each response text in the response text set is generated by the large language model for the request text; and selecting the plurality of response texts from the response text set based on the difference requirement.

In the technical solutions of the present disclosure, collection, obtaining, storage, use, processing, transmission, provision, disclosure, application, etc. of user personal information involved all comply with related laws and regulations and are not against the public order and good morals.

According to an embodiment of the present disclosure, there is further provided an electronic device, a readable storage medium, and a computer program product.

Referring to FIG. 5, a block diagram of a structure of an electronic device 500 that can serve as a server or a client of the present disclosure is now described. The electronic device is an example of a hardware device that can be applied to various aspects of the present disclosure. The electronic device is intended to represent various forms of digital electronic computer devices, such as a laptop computer, a desktop computer, a workstation, a personal digital assistant, a server, a blade server, a mainframe computer, and other suitable computers. The electronic device may further represent various forms of mobile apparatuses, such as a personal digital assistant, a cellular phone, a smartphone, a wearable device, and other similar computing apparatuses. The components shown in the present specification, their connections and relationships, and their functions are merely examples, and are not intended to limit the implementation of the present disclosure described and/or required herein.

As shown in FIG. 5, the electronic device 500 includes a computing unit 501. The computing unit may perform various appropriate actions and processing according to a computer program stored in a read-only memory (ROM) 502 or a computer program loaded from a storage unit 508 to a random access memory (RAM) 503. The RAM 503 may further store various programs and data required for the operation of the electronic device 500. The computing unit 501, the ROM 502, and the RAM 503 are connected to each other through a bus 504. An input/output (I/O) interface 505 is also connected to the bus 504.

A plurality of components in the electronic device 500 are connected to the I/O interface 505, including: an input unit 506, an output unit 507, the storage unit 508, and a communication unit 509. The input unit 506 may be any type of device through which information can be entered to the electronic device 500. The input unit 506 may receive entered digit or character information, and generate a key signal input related to user settings and/or function control of the electronic device, and may include, but is not limited to, a mouse, a keyboard, a touchscreen, a trackpad, a trackball, a joystick, a microphone, and/or a remote controller. The output unit 507 may be any type of device capable of presenting information, and may include, but is not limited to, a display, a speaker, a video/audio output terminal, a vibrator, and/or a printer. The storage unit 508 may include, but is not limited to, a magnetic disk and an optical disk. The communication unit 509 allows the electronic device 500 to exchange information/data with other devices via a computer network such as the Internet and/or various telecommunication networks, and may include, but is not limited to, a modem, a network interface card, an infrared communication device, a wireless communication transceiver, and/or a chipset, for example, a Bluetooth device, an 802.11 device, a Wi-Fi device, a WiMax device, or a cellular communication device.

The computing unit 501 may be various general-purpose and/or special-purpose processing components with processing and computing capabilities. Some examples of the computing unit 501 include, but are not limited to, a central processing unit (CPU), a graphics processing unit (GPU), various dedicated artificial intelligence (AI) computing chips, various computing units that run machine learning model algorithms, a digital signal processor (DSP), and any appropriate processor, controller, microcontroller, etc. The computing unit 501 performs the methods and processing described above, for example, the method 200 and variant examples thereof. For example, in some embodiments, the method 200 and the variant examples thereof, etc. may be implemented as a computer software program, which is tangibly contained in a machine-readable medium, such as the storage unit 508. In some embodiments, a part or all of the computer program may be loaded and/or installed onto the electronic device 500 via the ROM 502 and/or the communication unit 509. When the computer program is loaded into the RAM 503 and executed by the computing unit 501, one or more steps of the method 200 and the variant examples thereof described above, etc. can be performed. Alternatively, in other embodiments, the computing unit 501 may be configured, in any other suitable manner (for example, by using firmware), to perform the method 200 and the variant examples thereof, etc.

Various implementations of the systems and technologies described herein above can be implemented in a digital electronic circuit system, an integrated circuit system, a field programmable gate array (FPGA), an application-specific integrated circuit (ASIC), an application-specific standard product (ASSP), a system-on-chip (SOC) system, a complex programmable logical device (CPLD), computer hardware, firmware, software, and/or a combination thereof. These various implementations may include: implementation in one or more computer programs, where the one or more computer programs may be executed and/or interpreted on a programmable system including at least one programmable processor. The programmable processor may be a dedicated or general-purpose programmable processor that can receive data and instructions from a storage system, at least one input apparatus, and at least one output apparatus, and transmit data and instructions to the storage system, the at least one input apparatus, and the at least one output apparatus.

Program codes used to implement the method of the present disclosure can be written in any combination of one or more programming languages. The program code may be provided for a processor or a controller of a general-purpose computer, a special-purpose computer, or other programmable data processing apparatuses, such that when the program code is executed by the processor or the controller, the functions/operations specified in the flowcharts and/or block diagrams are implemented. The program code may be completely executed on a machine, or partially executed on a machine, or may be, as an independent software package, partially executed on a machine and partially executed on a remote machine, or completely executed on a remote machine or a server.

In the context of the present disclosure, the machine-readable medium may be a tangible medium, which may contain or store a program for use by an instruction execution system, apparatus, or device, or for use in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

In order to provide interaction with a user, the systems and technologies described herein can be implemented on a computer which has: a display apparatus (for example, a cathode-ray tube (CRT) or a liquid crystal display (LCD) monitor) configured to display information to the user; and a keyboard and a pointing apparatus (for example, a mouse or a trackball) through which the user can provide an input to the computer. Other categories of apparatuses can also be used to provide interaction with the user; for example, feedback provided to the user can be any form of sensory feedback (for example, visual feedback, auditory feedback, or tactile feedback); and an input from the user can be received in any form (including an acoustic input, a voice input, or a tactile input).

The systems and technologies described herein can be implemented in a computing system (for example, as a data server) including a backend component, or a computing system (for example, an application server) including a middleware component, or a computing system (for example, a user computer with a graphical user interface or a web browser through which the user can interact with the implementation of the systems and technologies described herein) including a frontend component, or a computing system including any combination of the backend component, the middleware component, or the frontend component. The components of the system can be connected to each other through digital data communication (for example, a communication network) in any form or medium. Examples of the communication network include: a local area network (LAN), a wide area network (WAN), and the Internet.

A computer system may include a client and a server. The client and the server are generally far away from each other and usually interact through a communication network. A relationship between the client and the server is generated by computer programs running on respective computers and having a client-server relationship with each other. The server may be a cloud server, a server in a distributed system, or a server combined with a blockchain.

It should be understood that steps may be reordered, added, or deleted based on the various forms of procedures shown above. For example, the steps recorded in the present disclosure may be performed in parallel, in order, or in a different order, provided that the desired result of the technical solutions disclosed in the present disclosure can be achieved, which is not limited herein.

Although the embodiments or examples of the present disclosure have been described with reference to the accompanying drawings, it should be appreciated that the method, system, and device described above are merely example embodiments or examples, and the scope of the present invention is not limited by the embodiments or examples, but defined only by the granted claims and the equivalent scope thereof. Various elements in the embodiments or examples may be omitted or substituted by equivalent elements thereof. Moreover, the steps may be performed in an order different from that described in the present disclosure. Further, various elements in the embodiments or examples may be combined in various ways. It is important that, as the technology evolves, many elements described herein may be replaced with equivalent elements that appear after the present disclosure.

What is claimed is:

1. An annotation method for a large language model, comprising:
obtaining a plurality of response texts that are generated by a large language model for a request text and that meet a difference requirement;
obtaining a plurality of scores corresponding to the plurality of response texts, wherein each score of the plurality of scores indicates a degree to which a response text corresponding to the score in the plurality of response texts matches the request text; and
obtaining an annotated text for at least one response text of the plurality of response texts based on the plurality of scores, wherein the annotated text is used to adjust a parameter of the large language model.

2. The method according to claim 1, wherein the obtaining an annotated text for at least one response text of the plurality of response texts based on the plurality of scores comprises:
determining a first response text as the annotated text in response to determining that a score, corresponding to the first response text, in the plurality of scores satisfies a threshold score condition.

3. The method according to claim 2, wherein the obtaining a plurality of scores corresponding to the plurality of response texts comprises: obtaining, for each response text of the plurality of response texts, a level selected from a plurality of predetermined ordered levels as a score for the response text,
and wherein the score satisfying the threshold score condition corresponds to the highest level of the plurality of ordered levels.

4. The method according to claim 1, wherein the obtaining an annotated text for at least one response text of the plurality of response texts based on the plurality of scores comprises:
determining a second response text satisfying a modification condition from the plurality of response texts, in response to determining that none of the plurality of scores satisfy a threshold score condition; and
obtaining a modified version of the second response text as the annotated text.

5. The method according to claim 1, wherein the obtaining an annotated text for at least one response text of the plurality of response texts based on the plurality of scores comprises:
obtaining an evaluation text for the at least one response text of the plurality of response texts as the annotated text, in response to determining that none of the plurality of scores satisfy a threshold score condition and to determining that the plurality of response texts comprise no response text satisfying a modification condition.

6. The method according to claim 1, wherein the difference requirement indicates at least one of the following: a word segmentation difference and a reward model-based difference between the response texts.

7. The method according to claim 1, further comprising: before the obtaining a plurality of scores corresponding to the plurality of response texts,
obtaining a plurality of pieces of critique data corresponding to the plurality of response texts, wherein each piece of critique data of the plurality of pieces of critique data indicates an error in a response text corresponding to the piece of critique data, and the plurality of pieces of critique data are used for display in association with the plurality of response texts.

8. The method according to claim 7, wherein the obtaining a plurality of pieces of critique data corresponding to the plurality of response texts comprises: obtaining the plurality of pieces of critique data by checking a degree to which each response text of the plurality of response texts matches the request text.

9. The method according to claim 7, wherein the obtaining a plurality of pieces of critique data corresponding to the plurality of response texts comprises: obtaining the plurality of pieces of critique data by checking correctness of a fact recorded in each response text of the plurality of response texts.

10. The method according to claim 7, wherein the obtaining a plurality of pieces of critique data corresponding to the plurality of response texts comprises: obtaining the plurality of pieces of critique data by checking language expression of each response text of the plurality of response texts.

11. The method according to claim 7, wherein the obtaining a plurality of pieces of critique data corresponding to the plurality of response texts comprises: obtaining the plurality of pieces of critique data by checking correctness of logic of each response text of the plurality of response texts.

12. The method according to claim 1, wherein the obtaining a plurality of response texts that are generated by a large language model for a request text and that meet a difference requirement comprises:
obtaining a response text set, wherein each response text in the response text set is generated by the large language model for the request text; and
selecting the plurality of response texts from the response text set based on the difference requirement.

13. An electronic device, comprising:
one or more processors;
a memory storing one or more programs configured to be executed by the one or more processors, the one or more programs including instructions for:
obtaining a plurality of response texts that are generated by a large language model for a request text and that meet a difference requirement;
obtaining a plurality of scores corresponding to the plurality of response texts, wherein each score of the plurality of scores indicates a degree to which a response text corresponding to the score in the plurality of response texts matches the request text; and
obtaining an annotated text for at least one response text of the plurality of response texts based on the plurality of scores, wherein the annotated text is used to adjust a parameter of the large language model.

14. The electronic device according to claim 13, wherein the obtaining an annotated text for at least one response text of the plurality of response texts based on the plurality of scores comprises:
determining a first response text as the annotated text in response to determining that a score, corresponding to the first response text, in the plurality of scores satisfies a threshold score condition.

15. The electronic device according to claim 14, wherein the obtaining a plurality of scores corresponding to the plurality of response texts comprises: obtaining, for each response text of the plurality of response texts, a level selected from a plurality of predetermined ordered levels as a score for the response text,
and wherein the score satisfying the threshold score condition corresponds to the highest level of the plurality of ordered levels.

16. The electronic device according to claim 14, wherein the obtaining an annotated text for at least one response text of the plurality of response texts based on the plurality of scores comprises:
determining a second response text satisfying a modification condition from the plurality of response texts, in response to determining that none of the plurality of scores satisfy a threshold score condition; and
obtaining a modified version of the second response text as the annotated text.

17. The electronic device according to claim 16, wherein the obtaining an annotated text for at least one response text of the plurality of response texts based on the plurality of scores comprises:
obtaining an evaluation text for the at least one response text of the plurality of response texts as the annotated text, in response to determining that none of the plurality of scores satisfy a threshold score condition and to determining that the plurality of response texts comprise no response text satisfying a modification condition.

18. The electronic device according to claim 13, wherein the difference requirement indicates at least one of the following: a word segmentation difference and a reward model-based difference between the response texts.

19. The electronic device according to claim 13, further comprising: before the obtaining a plurality of scores corresponding to the plurality of response texts, obtaining a plurality of pieces of critique data corresponding to the plurality of response texts, wherein each piece of critique data of the plurality of pieces of critique data indicates an error in a response text corresponding to the piece of critique data, and the plurality of pieces of critique data are used for display in association with the plurality of response texts.

20. A non-transitory computer-readable storage medium storing computer instructions, wherein the computer instructions are used to cause the computer to perform processing comprising: obtaining a plurality of response texts that are generated by a large language model for a request text and that meet a difference requirement;
obtaining a plurality of scores corresponding to the plurality of response texts, wherein each of the plurality of scores indicates a degree to which a corresponding response text in the plurality of response texts matches the request text; and
obtaining an annotated text for at least one of the plurality of response texts based on the plurality of scores, wherein the annotated text is used to adjust a parameter of the large language model.
